(19) United States
(12) Patent Application Publication
(10) Pub. No.: US 2008/0278637 A1
(43) Pub. Date: Nov. 13, 2008

(54) System and Method for Light Source Power Control

(75) Inventors: Gene Johnson, Carmel, IN (US); Angela Burnett, Indianapolis, IN (US); Carlton Simmons, Indianapolis, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/093,315

(22) PCT Filed: Nov. 30, 2005
(86) PCT No.: PCT/US05/43902

§ 371 Date: May 9, 2008

(51) Int. Cl. H04N 5/74; G09G 5/00

(52) U.S. Cl. 348/748; 345/211; 348/E05.137

(57) ABSTRACT

The disclosed embodiments relate to a system and method for light source power control. More specifically, there is provided a method of controlling a display device (10) light source (12) comprising intercepting a command to shut down a light source (12) and overriding the command to shut down the light source (12) if the command to shut down the light source (12) is issued before a predetermined time relative to a start of an event.

### FIELD OF THE INVENTION

The present invention relates generally to control of light sources used in the generation of images. More specifically, the invention relates to a system and method for ensuring timely power-up of a light source relative to a scheduled event.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Generally, the light sources or lamps used in the generation of images, for example in projection television sets, require a cool down period when turned off before they can be powered up again. This cool down period varies among manufacturers but may be as long as 60 seconds. Modern projection televisions may be programmed to turn-on at a specified time, for example, as a wake-up call or in order to view a specific program. After a television is programmed to turn-on at a scheduled time, a viewer may attempt to turn it off and not allow sufficient time for the light source to cool down prior to the scheduled turn-on event. The light source will then be unable to provide a timely picture according to that scheduled timed event. Degradation of performance and shortened life of the light source may result if the light source is not allowed to fully cool once entering a cool down period. In some existing systems, upon arrival of the scheduled turn-on event, the audio comes on but no picture is available until after the cool down period has passed.

An improved method or system is therefore needed to improve the availability of the light source or lamp to provide a picture at the beginning of a scheduled event.

### SUMMARY OF THE INVENTION

Certain aspects commensurate in the scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a system and method for improving lamp availability at the beginning of a scheduled event. More specifically, the system and method relate to intercepting a command to shut down a light source, overriding the command to shut down the light source if the command to shut down the light source is issued before a predetermined time relative to a start of an event.

### BRIEF DESCRIPTION OF THE DRAWINGS

Advantages of the invention may become apparent upon reading the following detailed description and upon reference to the drawings in which:

FIG. 1 is a block diagram of an exemplary image display unit in accordance with one embodiment of the present invention;

FIG. 2 is a block diagram generally showing a relationship between a programmable timer, an on/off circuit and a light source in accordance with embodiments of the present invention; and

FIG. 3 is a flow chart illustrating an exemplary technique for improving light source availability in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation specific decisions must be made to achieve the developer's specific goals, such as compliance with system related and business related constraints which may vary from one implementation to another. Moreover, it should be appreciated that such a development effort might be complex and time consuming, but would nevertheless be a routine undertaking of design fabrication and manufacture for those of ordinary skill having the benefit of this disclosure.

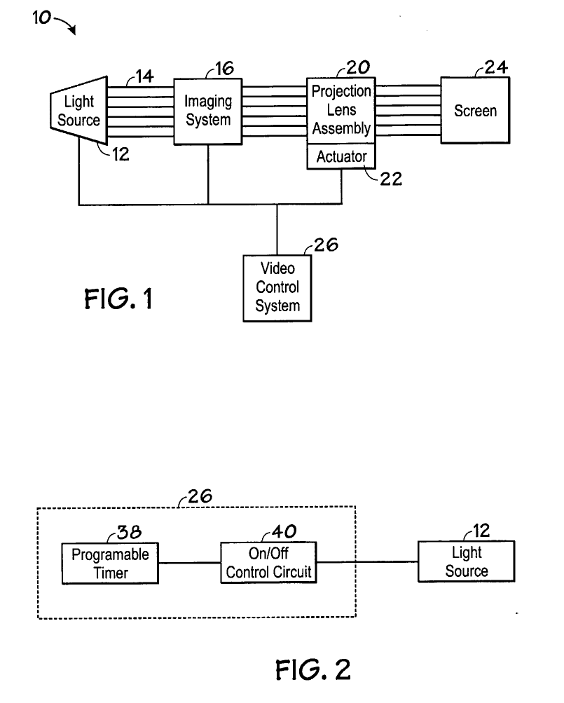

Turning initially to FIG. 1, a block diagram of an image display unit configured to display an image in accordance with one embodiment is illustrated and generally designated by a reference numeral 10. In one embodiment, the image display unit 10 may include a Digital Light Processing (“DLP”) projection television. In another embodiment, the image display unit 10 may include another form of projection television or projection display such as a Liquid Crystal Display (“LCD”).

The image display unit 10 includes a light source 12. The light source 12 may include any suitable form of lamp or bulb generally configured to project, shine, or direct light at or through an imaging system 16. In one embodiment the light source 12 may include a metal halide lamp, such as an ultra high performance (“UHP”) lamp, configured to shine white light through a color wheel (not shown) to create colored light.

As described above, image display unit 10 comprises a light source 12 which projects, directs or shines light 14 at or through an imaging system 16. The imaging system may comprise either a digital micromirror array in the case of a DLP television or a liquid crystal array in the case of an LCD unit. In the case of the DLP, for example, the light imaging system 16 may include a color wheel and further may comprise up to one-half-million or more micromirrors. The micromirrors are mounted on electrically-actuated hinges that enable the micromirrors to tilt between a turned on position and a turned off position. Each of the micromirrors corresponds to a pixel that is displayed on the screen 24 when light from the light source 12 is reflected off the micromirrors.

In the case of an LCD unit, the imaging system 16 may comprise an array of liquid crystals. The light from the light source can be projected through the liquid crystal array. The array of liquid crystals is electrically actuated to block light or allow light to pass through.

In either a DLP or LCD configuration of the image display unit 10, the light is passed through a projection lens assembly 20. The projection lens assembly 20 directs light from the imaging system 16 through a lens to a screen 24. The projection lens assembly 20 may be controlled by an actuator 22. The actuator may enable increased resolution on the screen 24 through pixel shifting technology. In other embodiments, not shown, more than one actuator may be used to enable the lens to shift pixels along more than one axis.

The light source 12, the imaging system 16 and the actuator 22 may be controlled by a video control system 26. The video control system 26 processes video input and controls the light source 12, the imaging system 16 and the actuator 22 as appropriate to create the video image seen on the screen 24 by a user. As such, the video control system 26 controls the turning on and off of the light source 12.

Turning to FIG. 2, an exemplary block diagram generally shows the video control system 26 being electrically coupled with the light source 12 in accordance with embodiments of the present invention. Specifically, FIG. 2 shows the video control system 26 comprising a programmable timer 38 and an on/off control circuit 40. The programmable timer 38 enables a user to set an image display unit, such as a DLP unit or an LCD unit, to turn-on at a specified scheduled time. This may be used, for example, as a reminder, alarm or in order to view a certain program. The programmable timer 38 is electrically coupled to the on/off control circuit 40. The on/off control circuit 40 controls the turning off and turning on of the image display unit 10 and consequently the light source 12.

In accordance with an exemplary embodiment of the present invention, when a user attempts to turn-off the image display unit 10, the on/off control circuit 40 determines if there is a preprogrammed turn-on time wherein the light source 12 would need to be available. If turning off the image display unit 10 would send the light source 12 into a cooling cycle and not allow sufficient cool down time before the light source 12 would need to be available for the scheduled event, the on/off control circuit 40 overrides the shut down command and places the unit in a mute and blank mode.

The mute and blank mode is in lieu of turning off the unit 10 and placing the light source 12 in a cool down cycle. In the mute and blank mode the unit does not display images and also does not produce sound. The light source 12 is never turned off, thus bypassing a cool down period which would have been necessitated by turning the image display unit 10 and light source 12 off. In this manner, the light source 12 and the unit 10 will be enabled to power on according to the predetermined time scheduled by the user and the programmable timer 30.

According to an alternate embodiment, upon receiving a turn-off signal from a user that would not allow sufficient time for the light source to cool, the television would allow the user to select whether or not to mute and blank the television. Specifically, the user could select from at least three options: send the television into a mute and blank mode, leave the television on or turn the television off. If the user chooses to place the television into a mute and blank mode or to leave the television on, the light source 12 will be available in a timely manner with respect to the scheduled turn-on event. However, if the user selects to turn-off the television, the light source will enter a cool down period and will not be available when the scheduled time arrives for turn-on.

An image display unit may be programmed in order to allow a user to select a particular embodiment, either automatically muting and blanking or providing the user with options, according to the user's personal preferences. Alternatively, a display unit may be programmed to only implement one of the above mentioned embodiments.

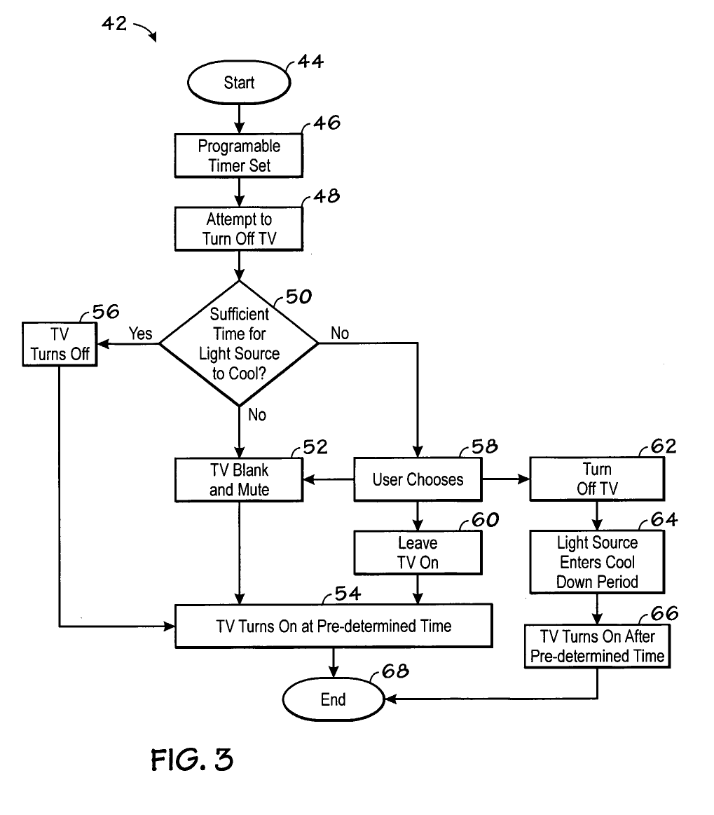

FIG. 3 is a flow chart illustrating an exemplary technique for improving light source availability according to a scheduled event in accordance with embodiments of the present invention and is generally designated by the reference numeral 42. Initially, the image display unit is on (block 44) and a programmable timer is set to turn-on the TV at a predetermined time (block 46). As discussed earlier, this time may coincide with the start of a certain program or may serve as an alarm to the user among other things.

After the programmable timer 38 has been set a user attempts to turn-off off the image display unit (block 48). The on/off circuit 40 determines if there will be sufficient time for the light source 12 to adequately cool prior to the scheduled event (block 50). If turning off the television allows sufficient time for the lamp to cool, such that the lamp will be available at the pre-scheduled turn-on time, the unit is turned off (block 56).

If, however, the attempted turn-off does not allow sufficient time for the light source to cool before the scheduled turn-on according to the preprogrammed time, the on/off control circuit 40 overrides the turn-off command and the image display unit enters a blank and mute mode (block 52) or asks the user if they really want to turn-off the unit (block 58). In a blank and mute mode no image is displayed and no sound is provided until the pre-scheduled time. This blank and mute mode is preferable to the conventional method because it allows the bypass of the cool down period for the light source 12 and the unit is able to turn-on according to the predetermined time as scheduled by the user in the programmable timer 30 (block 54).

Alternatively, as indicated, the unit may ask the user if they really want to turn-off the unit. The user can then chose to turn-off the unit, place the unit in a blank and mute state, or leave the unit on. If the user chooses to blank and mute the unit (block 52) or to leave the unit on (block 60), the unit is available according to the preprogrammed event for timely turn-on (block 54). However, if the user selects to turn the unit off (block 62) the light source enters a cooling period (block 64) and the unit will not turn on according to the scheduled turn-on event, but rather after the cool down cycle finishes (block 66). Once the unit is turned on for the scheduled event, the technique 42 ends (block 68).

The image display unit may be manufactured to automatically enter a blank and mute state or to allow a user to make a selection to avoid sending the image display unit into a cooling period when there is not sufficient time for the light source to cool prior to a scheduled event. Alternatively, the image display unit can be manufactured to allow for both methods and permit the user to program the unit to operate according to a user's preferred method. The unit may be enabled to allow a user to select a preference when initially setting up the image display unit or each time the programmable timer is set.

While the invention may be susceptible to various modifications and alternative forms, specific embodiments have been shown by way of example in the drawings and described in detail herein. However, it should be understood that the invention is not intended to be limited to the particular forms disclosed, rather the invention is to cover all modifications, equivalents and alternatives falling within the spirit and scope of the invention as defined by the following appended claims.

What is claimed is:

1. A display device (10), comprising:
a programmable timer (38) adapted to start the display device (10) at a predetermined time; and
a control circuit (40) that controls a light source (12), the light source (12) having a cool-down period, the control circuit (40) being adapted to override a command to shut down the light source (12) issued before the predetermined time and within the cool-down period with respect to the predetermined time.

2. The display device (10) according to claim 1, wherein the command to shutdown is a manual input by a user.

3. The display device (10) according to claim 1, wherein the device blanks a display screen (24) and mutes a volume to override the command to shutdown.

4. The display device (10) according to claim 1, wherein the command to shut down produces a menu allowing a user to select to have the device remain on, enter into a blank and mute state, or turn-off.

5. The display device (10) according to claim 1, wherein the display device (10) comprises a digital light processing (“DLP”) system.

6. The display device (10) according to claim 1, wherein the display device (10) comprises a liquid crystal display (“LCD”) system.

7. The display device (10) according to claim 1, wherein the device is adapted to implement pixel shifting.

8. A method of controlling a display device (10), the method comprising:
intercepting a command to shut down a light source (12); and
overriding the command to shut down the light source (12) if the command to shut down the light source (12) is issued before a predetermined time relative to a start of an event.

9. The method according to claim 8, wherein the command to shutdown comprises a manual input by a user.

10. The method according to claim 8, wherein overriding the command to shutdown comprises muting a volume and blanking a screen (24) of the display device (10).

11. The method according to claim 8, wherein overriding a command to shutdown comprises allowing a user to select to have the device (10) remain on, enter into a blank and mute state, or turn-off.

12. The method according to claim 8, wherein the display device (10) comprises a digital micromirror array.

13. The method according to claim 8, wherein the display device (10) comprises a liquid crystal array.

14. The method according to claim 8, wherein the predetermined time is programmed into the display device (10) by a user.

15. A television (10), comprising:
a light source (12) having a cool-down period configured to produce light (14);
an imaging system (16) configured to receive and process light (14) from the light source (12) to produce pixels of a displayed image;
a projection lens (20) configured to direct the pixels to a screen (24) to produce the displayed image;
a programmable timer (38) adapted to start the display device (10) at a predetermined time; and
a control circuit (40) that controls the light source (12), the control circuit (40) being adapted to override a command to shut down the light source (12) issued before the predetermined time and within the cool-down period with respect to the predetermined time.

16. The television (10) according to claim 15, wherein the command to shutdown is a manual input by a user.

17. The television (10) according to claim 15, wherein overriding the command to shutdown comprises muting a volume and blanking a screen (24) of the television.

18. The television (10) according to claim 15, wherein a user may select to have the television (10) remain on, enter into a blank and mute state, or turn-off following the command to shut down.

19. The television (10) according to claim 15, wherein the imaging system (16) comprises a digital micromirror array.

20. The television (10) according to claim 15, wherein the imaging system (16) comprises a liquid crystal array.
